(19) United States
(12) Patent Application Publication
(10) Pub. No.: US 2025/0193708 A1
(43) Pub. Date: Jun. 12, 2025

(54) BACKUP MODE MANAGEMENT IN A WIRELESS SYSTEM

(71) Applicant: Charter Communications Opearating, LLC, St. Louis, MO (US)

(72) Inventors: David J. Rodrian, Littleton, CO (US); Srinivasa V. Ramani, Aurora, CO (US); Devaki E. Jordan, Aurora, CO (US); Jared P. Harper, Highlands Ranch, CO (US); Nereus Osric Edwin Lobo, Denver, CO (US); Thomas P. Cawley, IV, Englewood, CO (US)

(21) Appl. No.: 18/535,499

(22) Filed: Dec. 11, 2023

(51) Int. Cl. H04W 24/04; H04L 41/0654

(52) U.S. Cl. CPC H04W 24/04; H04L 41/0654

(57) ABSTRACT

A communication management resource (such as a wireless access point evaluator) receives a notification indicating operation of a wireless station (such as wireless access point) in a battery backup mode. In response to receiving the notification, the communication management resource monitors wireless services provided by the wireless station while the wireless station is operated in the battery backup mode. Based on the monitored wireless services, the communication management resource determines a condition causing the operation of the wireless station in the battery backup mode. The communication management resource potentially provides one or more notifications indicating a possible reason why the wireless station operates in the battery backup mode.

### BACKGROUND

A conventional Wireless Access Point (WAP) such as a router is typically deployed in a corresponding subscriber domain to provide wireless services to one or more communication devices. In general, a communication device establishes a respective wireless connection with the wireless access point. In an uplink direction, the respective communication device is able to wirelessly transmit data to the wireless access point; the wireless access point forwards the data to a corresponding target entity in a remote network. In a downlink direction, the respective target entity in the remote network transmits communications (destined for the communication device) to the wireless access point; the wireless access point wirelessly transmits the communications over the respective wireless communication link to the communication device.

It is noted that a conventional router such as a wireless access point is typically powered by a power source in a domain such as a home, business, etc., such as 120 volts AC converted to 12 volts DC supplied to the wireless access point. During a power outage, the 120 volts AC may not be available resulting in discontinued operation of the wireless access point.

### BRIEF DESCRIPTION OF EXAMPLES

There are deficiencies associated with conventional techniques of providing wireless access to users in a respective network environment. For example, in the event that the customer or subscriber domain such as home, business, etc., loses primary power provided by the 120 volts AC, the conventional wireless access point is unable to provide wireless connectivity to a remote network such as the Internet without battery backup. One solution is to configure the wireless access point with battery backup to avoid this issue. In such an instance, during a condition of losing primary power to the subscriber domain (any serviced environment such as home, business, etc.), the wireless access point can be configured to switchover to receiving power from a battery. Additionally, it is possible that a primary communication path between the wireless access point and the remote network such as through a gateway or cable modem is no longer functional during a respective power outage.

In addition to providing battery backup capability to the wireless access point, the wireless access point can be configured to include a supplemental wireless interface providing the wireless access point an alternative path to communicate with the remote network in the event that the primary communication path is not functional. Thus, the wireless access point having battery backup capability as well as the supplemental wireless interface (such as cellular) provides continuous wireless services to communication devices in the serviced network environment (such as domain) even though primary power supply to the serviced network environment (such as domain) may fail.

In other words, it may be desirable to offer a wireless access point with cellular and battery backup capability because such a novel wireless access point provides customers in the subscriber domain with the ability to maintain critical connectivity to the internet or other remote network for a period of time even though there is loss of power and/or connectivity of the primary communication path. (e.g., loss of power to the customer's premise, loss of internet provided over cable/fiber modem to the router)

As further discussed herein, this disclosure proposes leveraging network intelligence and/or Advanced Device Identification to determine if the outage observed was regional or local in nature (i.e. at a router level). More specifically, based on monitoring the powered devices connected to the wireless access point (a.k.a., router) before and after the wireless access point switches over to the battery backup mode (where the wireless access point receives power from the battery as well as implements the supplemental wireless interface to provide connectivity to the remote network), the communication management hardware as discussed herein determines whether the power outage was noticed across the entire household or just for the specific router.

It is further noted that operation and/or switchover of the wireless access point from the primary power to the battery backup power can be caused by a number of different conditions. For example, a user may routinely terminate or turn off power provided to the wireless access point and/or modem supporting the primary communication path for any number of reasons such as no one in the subscriber domain uses the Internet at night or no one in the subscriber domain uses the Internet outside of business hours.

As another example, the user in the subscriber domain may accidentally unplug or shut off power to the wireless access point. Accidental or unnecessary switchover of the wireless access point from the primary wall power to the battery backup mode may be undesirable for any number of reasons. For example, operating the wireless access point in the battery backup mode when not needed depletes energy in the battery that may be needed when a regional power outage occurs. Additionally, switchover to use of the supplemental wireless interface (such as cellular) during the battery backup mode may incur additional wireless charges to the customer because the secondary wireless interfaces used to support connectivity with the remote network.

In certain examples as discussed herein, a communication management resource can be configured to determine whether the switchover to the battery backup mode and use of the supplemental wireless interface was caused by the accidental loss of power to the wireless access point (such as caused by the one or more occupants in or associated with the subscriber domain) or if the loss of power to the wireless access point is caused by another condition such as a power outage to the home environment which is out of the control of the persons in the subscriber domain such as home or business environment.

In the case where the wireless access point loses power due to a condition outside the control of the persons in the subscriber domain, there may be no need to provide notification of the reason for the switchover. Conversely, in the case with the wireless access point loses power due to an accidental condition inside control of the occupants of or associated with the subscriber domain such as the wireless access point being unplugged, the communication management resource as discussed herein can be configured to provide notification to occupants in the subscriber domain environment regarding the possible accidental switchover of the wireless access point to the battery backup mode. In this latter instance, the one or more occupants in the subscriber domain environment can be notified to proactively check their router connection status (such as 12 volt DC power supply to the wireless access point and/or connectivity of the wireless access point to the primary communication path). If desired, the entity provided network access services may allow throttling down wireless bandwidth associated with the wireless access point or temporarily disable the supplemental wireless interface (such as cellular) to prevent additional cellular data use charges when they are not necessary because primary power is available. For example, a modification request may allow the ISP (Internet Service Provider) to throttle uplink and/or downlink bandwidth without an explicit notification to the customer (a notice may be provided in terms of use or acceptable use policy to the customer).

Examples herein therefore provide an improved way of implementing backup capability associated with a respective wireless access point.

More specifically, in one example, a communication management resource (such as a wireless access point evaluator) receives a notification indicating operation of a wireless station (such as wireless access point) in a battery backup mode. In response to receiving the notification, the communication management resource monitors wireless services provided by the wireless station while the wireless station is operated in the battery backup mode. Based on the monitored wireless services, the communication management resource determines a condition causing the operation of the wireless station in the battery backup mode.

In one example, the condition causing the wireless access point to operate in the battery backup mode is determined by the communication management resource to be a subscriber (such as occupant in the subscriber domain environment) accidentally or intentionally terminating application of primary power to the wireless station; the termination of the primary power to the wireless station causes the wireless station to switch over from a normal operational mode to the battery backup mode. If desired, the communication management resource can be configured to provide notification of the condition to a user (such as an occupant) in a subscriber domain (such as subscriber domain environment) in which the wireless station resides. In such an instance, when the de-powering of the wireless station (such as a wireless access point) is determined to be unintentional, the corresponding one or more occupants in the subscriber domain are able to easily fix the problem by applying appropriate power to the wireless station. For example, the occupant in the subscriber domain environment can plug in the wireless access point to the wall power such as 120 volt AC, causing the wireless station to switch back to a normal operational mode (such as a non-battery backup mode).

In accordance with further examples as discussed herein, the condition may be determined by the communication management resource to be a loss of primary power supplied to the wireless station, the loss of primary power caused by a power outage in a household in which the wireless station resides.

In still further examples, note that the wireless services monitored by the communication management resource may include monitoring a first wireless communication link between a first communication device and the wireless station. In such an instance, the monitoring by the communication management resource can be configured to include: receiving an identity of a first communication device provided access to a remote network through the wireless station via the first wireless communication link; and mapping the identity of the first communication device to attributes of the first communication device, the attributes of the first communication device indicating that the first communication device is a stationary device disposed in a subscriber domain serviced by the wireless station. Yet further, in response to detecting that the first communication device is a stationary device, and that the stationary device is one that is normally powered by a primary power supplied to a subscriber domain in which the wireless station resides, the communication management resource determines that the condition causing the operation of the wireless station in the battery backup mode resulted from a user in the subscriber domain terminating application of primary power to the wireless station.

In still further examples as discussed herein, the wireless station includes a primary communication interface and a secondary communication interface to communicate with a remote network. The primary communication interface provides connectivity of the wireless station to the remote network through a gateway and a wired communication link. The secondary communication interface provides connectivity of the wireless station to the remote network through a wireless communication link. The operation of the wireless station in the battery backup mode may include the wireless station providing connectivity of a first communication device to the remote network via communications through the secondary communication interface and over the wireless communication link.

In another example, determination of the condition causing the wireless station to operate in the battery backup mode includes the communication management resource detecting multiple communication devices in communication with the wireless station while the wireless station is in the battery backup mode. Assume that the multiple communication devices are provided connectivity through the wireless station to the remote network while the wireless station is in the battery backup mode. In such an instance, the communication management resource can be configured to produce a numerical value indicating how many of the multiple communication devices are stationary in a subscriber domain in which the wireless station resides. The communication management resource compares a magnitude of the numerical value to a threshold level and determines a type associated with the condition (such as loss of primary power to the subscriber domain environment, occupant unplugging the wireless access point from the wall power, etc.) based on the comparison of the numerical value to the threshold level.

In still further examples, monitoring and analysis of the wireless services includes the communication management resource: i) receiving first connectivity information indicating a first set of communication devices provided wireless connectivity to the wireless station prior to the operation of the wireless station in the battery backup mode; and ii) receiving second connectivity information indicating a second set of communication devices provided wireless connectivity to the wireless station during the operation of the while the wireless station is operated identities of a second set of communication devices the first communication devices. The communication management resource can be configured to determine the condition causing the operation of the wireless station in the battery backup mode via comparison of the first connectivity information and the second connectivity information. The comparison indicates which of one or more communication devices no longer communicate with the wireless station after switchover of the wireless station to the battery backup mode. As previously discussed, such information can be used to infer because of the wireless access point operating in the battery backup mode.

Note that any of the resources as discussed herein can include one or more computerized devices, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium, computer readable hardware storage, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, executable instructions, etc., that supports operations as discussed herein.

One example includes a computer readable storage medium and/or system having instructions stored thereon to facilitate control or management of communications in a network environment. The instructions, when executed by computer processor hardware, cause the computer processor hardware (such as one or more co-located or disparately processor devices) to: receive a notification indicating operation of a wireless station in a battery backup mode; in response to receiving the notification, analyze wireless services provided by the wireless station while the wireless station is operated in the battery backup mode; and based on the wireless services, determining a condition causing the operation of the wireless station in the battery backup mode.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved and extended wireless services to communication devices. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a wireless communication system providing wireless connectivity to multiple communication devices as discussed herein.

FIG. 2 is an example diagram illustrating a snapshot of wireless services provided by a wireless access point to multiple communication devices prior to switchover of the wireless access point to a backup mode as discussed herein.

FIG. 3 is an example diagram illustrating a wireless system operating in a battery backup mode to provide wireless services to communication devices in a subscriber domain as discussed herein.

FIG. 4 is an example diagram illustrating a snapshot of wireless services provided by a wireless access point to communication devices after switchover of the wireless access point to backup power as discussed herein.

FIG. 5 is an example diagram illustrating communication of a notification to one or more communication devices indicating a detected cause associated with operating the wireless access point in a battery backup mode as discussed herein.

FIG. 6 is an example diagram illustrating a wireless system operating a battery backup mode to provide wireless services to communication devices in a subscriber domain as discussed herein.

FIG. 7 is an example diagram illustrating a snapshot of wireless services provided by a wireless access point after switchover of the wireless access point to a backup mode as discussed herein.

FIG. 8 is an example diagram illustrating communication of a notification indicating a detected cause associated with operating the wireless access point in a battery backup mode as discussed herein.

FIGS. 9 and 10 are example flowcharts illustrating operations associated with a wireless system as discussed herein.

FIG. 11 is an example diagram illustrating operations and communications associated with a wireless system configured to provide backup capability as discussed herein.

FIG. 12 is a diagram illustrating an example computer architecture to execute one or more operations as described herein.

FIG. 13 is an example diagram illustrating a method as described herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

A communication management resource (such as a wireless access point evaluator) receives a notification indicating operation of a wireless station (such as wireless access point) in a battery backup mode. In response to receiving the notification, the communication management resource analyzes wireless services provided by the wireless station while the wireless station is operated in the battery backup mode. Based on the monitored wireless services, the communication management resource determines a condition causing the operation of the wireless station in the battery backup mode. The communication management resource potentially provides one or more notifications indicating a possible reason why the wireless station operates in the battery backup mode to persons in the subscriber domain service by the wireless access point.

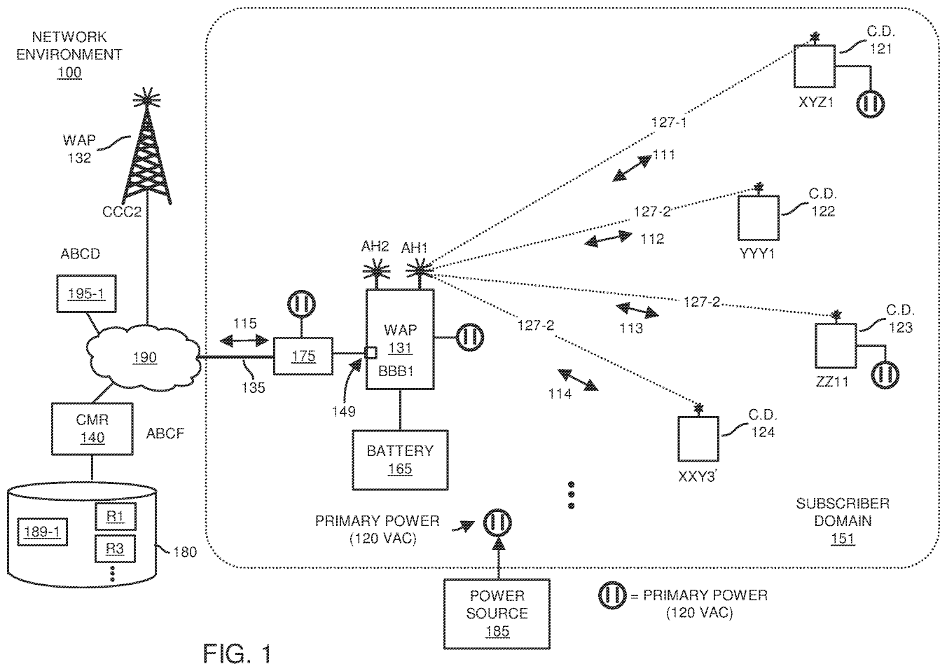

Now, more specifically, FIG. 1 is an example diagram illustrating a wireless communication system providing wireless connectivity to multiple communication devices as discussed herein.

As shown in this example, network environment 100 includes wireless access point 131, gateway 175 such as a modem or other suitable entity, wireless access point 132 (a.k.a., wireless base station), server resource 195-1, communication management resource 140, and repository 180.

Note that each of the resources (such as gateway 175, wireless access point 131, communication devices, communication management resource 140, wireless access point 132, communication device 121, communication device 122, etc.) in network environment 100 can be configured to include appropriate hardware, software, or combination of hardware and software to carry out respective operations as discussed herein.

More specifically, the communication management resource 140 can be configured as communication management hardware, communication management software, or a combination of communication management hardware and communication management software; the wireless access point 131 can be configured as wireless access point hardware, wireless access point software, or a combination of wireless access point hardware and wireless access point software; the wireless access point 132 can be configured as wireless access point hardware, wireless access point software, or a combination of wireless access point hardware and wireless access point software; mobile communication device 121 can be configured as communication device hardware, communication device software, or a combination of communication device hardware and communication device software; mobile communication device 122 can be configured as communication device hardware, communication device software, or a combination of communication device hardware and communication device software; communication device 123 can be configured as communication device hardware, communication device software, or a combination of communication device hardware and communication device software; communication device 124 can be configured as communication device hardware, communication device software, or a combination of communication device hardware and communication device software; gateway 175 can be configured as gateway hardware, gateway software, or a combination of gateway hardware and gateway software; and so on.

The subscriber domain 151 is provided power such as 120 volts AC or other suitable voltage from the power source 185 (such as a utility company, power generator, or other suitable entity providing power services).

As shown in FIG. 1, when the power source 185 provides the primary power to the subscriber domain 151, the components such as gateway 175, wireless access point 131, communication device 121, and communication device 123, etc., are powered by the primary power such as 120 volts AC.

Note that the communication device 122 and communication device 124 may not be powered by the primary power supplied by the power source 185. Instead, the communication device 122 can be configured to include a respective battery to power the communication device 122. The communication device 124 can be configured to include a respective battery to power the communication device 124. This allows mobility of those communication devices.

Accordingly, when there is a loss of primary power provided by the power source 185 to the subscriber domain 151, the communication device 175, wireless access point 131, communication device 121, and communication device 123 no longer operate. However, note that the battery 165 (such as a battery backup unit) can be configured to provide the wireless access point 131 backup power during a respective condition in which the primary power is no longer supplied to the wireless access point 131.

During a normal operational mode such as a non-power outage condition, the battery 165 may be charged via primary power provided by the power source 185. When operating in a respective backup mode, the wireless access point 131 and/or gateway 175 receive power from the battery 165.

Notably, the wireless access point 131 includes antenna hardware AH1 and antenna hardware AH2. As shown, during the normal operational mode in which both the wireless access point 131 and the communication device 175 are powered by the primary power such as 120 volts AC, the wireless access point 131 implements use of the antenna hardware AH1 to provide wireless connectivity (wireless services) to multiple communication devices including communication device 121, communication device 122, communication device 123, communication device 124, etc.

More specifically, during the normal operational mode when primary power is provided to the subscriber domain 151 via the power source 185, the wireless access point 131 provides wireless services via a respective wireless communication link to each of the communication devices including communication device 121, communication device 122, communication device 123, and communication device 124.

Note that each of the respective entities such as communication device 121, communication device 122, communication device 123, communication device 124, wireless access point 131, gateway 175, server resource 195-1, communication management resource 140, etc., in the network environment 100 can be assigned a respective network address facilitating delivery of communications between each other.

As a more specific example, the server resource 195-1 is assigned the unique network address ABCD; the communication management resource 140 is assigned a unique network address ABCF; the wireless access point 131 is assigned the unique network address BBB1; the communication device 121 is assigned a unique network address XYZ1; the communication device 122 is assigned a unique network address YYY1; the communication device 123 is assigned a unique network address ZZ11; the communication device 124 is assigned unique network address XXY3; and so on.

Transmission of corresponding messages between entities in the network via 100 include a corresponding entity including its own assigned network address as a source network address and a destination network address indicating a corresponding entity to which the message is being transmitted. The network environment 100 is configured to convey a respective message to a destination network address as specified by the respective message.

Further in this example, the wireless communication link 127-1 established between the antenna AH1 of the wireless access point 131 and the communication device 121 (such as a stationary communication device at a fixed position that does not move about the subscriber domain 151) supports communications 111 including both uplink communications and downlink communications. Uplink communications associated with the communications 111 include the communication device 121 communicating messages over the wireless communication link 127-1 to the antenna hardware AH1 of the wireless access point 131. Via the communications 115, the wireless access point 131 forwards uplink messages received from the communication device 121 over the antenna hardware AH1 through the gateway 175 over the shared communication link 135 and network 190 to a specified destination such as server resource 195-1 or other suitable entity in the network environment 100. Further, via the communications 115, the server resource 195-1 or other suitable entity forwards downlink messages through the network 190 and the gateway 175 to the wireless access point 131. The wireless access point 131 further forwards any communications destined for delivery to the communication device 121 over the wireless communication link 127-1 via the communications 111.

The wireless communication link 127-2 established between the antenna AH1 of the wireless access point 131 and the communication device 122 (such as a mobile communication device that is free to move about the subscriber domain 151) supports communications 112 including both uplink communications and downlink communications. Uplink communications associated with the communications 112 include the communication device 122 communicating messages over the wireless communication link 127-2 to the antenna hardware AH1 of the wireless access point 131. Via the communications 115, the wireless access point 131 forwards uplink messages received from the communication device 122 over the antenna hardware AH1 through the gateway 175 over the shared communication link 135 and network 190 to a specified destination such as server resource 195-1 or other suitable entity in the network environment 100. Further, via the communications 115, the server resource 195-1 or other suitable entity forwards downlink messages through the network 190 and the gateway 175 to the wireless access point 131. The wireless access point 131 further forwards any communications destined for delivery to the communication device 122 over the wireless communication link 127-2 via the communications 112.

Further in this example, the wireless communication link 127-3 established between the antenna AH1 of the wireless access point 131 and the communication device 123 (such as a stationary communication device at a fixed position that does not move about the subscriber domain 151) supports communications 113 including both uplink communications and downlink communications. Uplink communications associated with the communications 113 include the communication device 123 communicating messages over the wireless communication link 127-3 to the antenna hardware AH1 of the wireless access point 131. Via the communications 115, the wireless access point 131 forwards uplink messages received from the communication device 123 over the antenna hardware AH1 through the gateway 175 over the shared communication link 135 and network 190 to a specified destination such as server resource 195-1 or other suitable entity in the network environment 100. Further, via the communications 115, the server resource 195-1 or other suitable entity forwards downlink messages through the network 190 and the gateway 175 to the wireless access point 131. The wireless access point 131 further forwards any communications destined for delivery to the communication device 123 over the wireless communication link 127-3 via the communications 113.

The wireless communication link 127-4 established between the antenna AH1 of the wireless access point 131 and the communication device 124 (such as a mobile communication device that is free to move about the subscriber domain 151) supports communications 114 including both uplink communications and downlink communications. Uplink communications associated with the communications 114 include the communication device 124 communicating messages over the wireless communication link 127-4 to the antenna hardware AH1 of the wireless access point 131. Via the communications 115, the wireless access point 131 forwards uplink messages received from the communication device 122 over the antenna hardware AH1 through the gateway 175 over the shared communication link 135 and network 190 to a specified destination such as server resource 195-1 or other suitable entity in the network environment 100. Further, via the communications 115, the server resource 195-1 or other suitable entity forwards downlink messages through the network 190 and the gateway 175 to the wireless access point 131. The wireless access point 131 further forwards any communications destined for delivery to the communication device 124 over the wireless communication link 127-4 via the communications 114.

As further shown, the communication management resource 140 (such as any one or more different functions providing management of operations in the network environment 100) is in communication with the wireless access point 131 via a respective communication path including the gateway 175, shared communication link 135, and network 190. Via the communication path, the wireless access point 131 or other suitable entity generates status information such as indicating a current operational mode of the wireless access point 131 and whether it is operating off primary power supplied by the power source 185 or backup power provided by the battery 165.

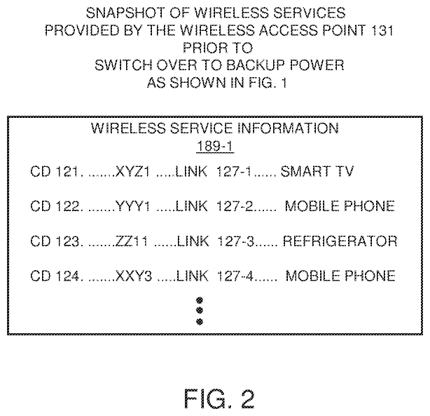

Additionally, via the communication path, the communication management resource receives status information 189-1 indicating the different wireless services provided by the wireless access point 131 at a particular one or more instances of time. An example of the status information 189-1 shown in FIG. 2.

FIG. 2 is an example diagram illustrating a snapshot of wireless services provided by a wireless access point to multiple communication devices prior to switchover of the wireless access point to a backup mode as discussed herein.

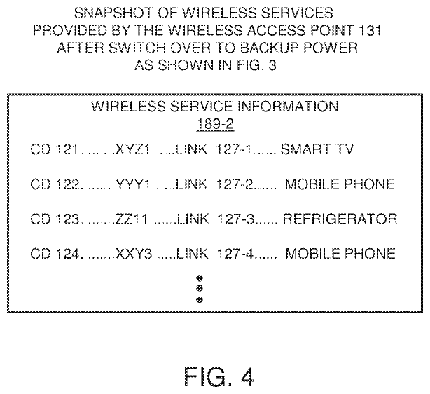

In one example, the status information 189-1 is a snapshot of information for a given instant of time indicating wireless services provided by the wireless access point 131 to one or more entities in the subscriber domain 151 while the wireless access point 131 operates in a normal power mode is shown in FIG. 1 prior to switchover of the wireless access point 131 being powered by the battery 165 as shown in FIG. 4.

Referring again to FIG. 2, the status information 189-1 (a.k.a., wireless service information) in this example indicates that the wireless access point 131 provides wireless services to communication device 121 assigned the unique identifier value XYZ1 over the wireless communication link 127-1. Note that the communication management resource 140 or other suitable entity such as a wireless access point 131 can be configured to determine a type associated with the communication device 121 in any suitable manner. For example, the wireless access point 131 can be configured to communicate with the communication device 121 or other suitable entity to retrieve information (such as device type, manufacture, model #, etc.) indicating that communication device 121 is a smart TV. In this example, in response to receiving the attribute information associated with the communication device 121, the status information 189-1 is generated to indicate one or more attributes such as: i) that the communication device 121 is a stationary communication device such as a smart TV that does not move about the subscriber domain 151, ii) that the communication device 121 is powered by the primary power supplied by the power source 175 and that loss of the primary power results in shutoff of the communication device 121. Note that the attributes associated with the communication device 121 can be determined in any suitable manner such as based on a corresponding network address assigned to the communication device 121, attribute information stored in the communication device 121, a device identifier assigned to the communication device 121 indicating its attributes or type, etc.

The status information 189-1 in this example indicates that the wireless access point 131 provides wireless services to communication device 122 assigned the unique identifier value YYZ1 over the wireless communication link 127-2. Note that the communication management resource 140 or other suitable entity such as a wireless access point 131 can be configured to determine a type associated with the communication device 122 in any suitable manner. For example, the wireless access point 131 can be configured to communicate with the communication device 122 or other suitable entity to retrieve information (such as device type, manufacture, model #, etc.) indicating that communication device 122 is a mobile phone operated by a respective user. In this example, in response to receiving the attribute information associated with the communication device 122, the status information 189-1 is generated to indicate one or more attributes such as: i) that the communication device 122 is a mobile communication device that moves about the subscriber domain 151, ii) that the communication device 122 is powered by a battery and not the primary power supplied by the power source 175 and that loss of the primary power does not result in in shutoff of the communication device 122. Note that the attributes associated with the communication device 122 can be determined in any suitable manner such as based on a corresponding network address assigned to the communication device 121, attribute information stored in the communication device 121, a device identifier assigned to the communication device 121 indicating its attributes or type, etc.

The status information 189-1 in this example indicates that the wireless access point 131 provides wireless services to communication device 123 assigned the unique identifier value ZZ11 over the wireless communication link 127-3. Note that the communication management resource 140 or other suitable entity such as a wireless access point 131 can be configured to determine a type associated with the communication device 123 in any suitable manner. For example, the wireless access point 131 can be configured to communicate with the communication device 123 or other suitable entity to retrieve information (such as device type, manufacture, model #, etc.) indicating that communication device 123 is a stationary device such as a refrigerator powered by the primary power only. In this example, in response to receiving the attribute information associated with the communication device 123, the status information 189-1 is generated to indicate one or more attributes such as: i) that the communication device 121 is a stationary refrigerator that does not move about the subscriber domain 151, ii) that the communication device 123 is powered by the primary power supplied by the power source 175 and that loss of the primary power results in shutoff of the communication device 123. Note that the attributes associated with the communication device 123 can be determined in any suitable manner such as based on a corresponding network address assigned to the communication device 123, attribute information stored in the communication device 123, a device identifier assigned to the communication device 123 indicating its attributes or type, etc.

The status information 189-1 in this example indicates that the wireless access point 131 provides wireless services to communication device 124 assigned the unique identifier value XXY3 over the wireless communication link 127-4. Note that the communication management resource 140 or other suitable entity such as a wireless access point 131 can be configured to determine a type associated with the communication device 124 in any suitable manner. For example, the wireless access point 131 can be configured to communicate with the communication device 124 or other suitable entity to retrieve information (such as device type, manufacture, model #, etc.) indicating that communication device 124 is a mobile phone operated by a respective user. In this example, in response to receiving the attribute information associated with the communication device 124, the status information 189-1 is generated to indicate one or more attributes such as: i) that the communication device 124 is a mobile communication device that moves about the subscriber domain 151, ii) that the communication device 124 is powered by a battery and not the primary power supplied by the power source 175 and that loss of the primary power does not result in in shutoff of the communication device 124. Note that the attributes associated with the communication device 124 can be determined in any suitable manner such as based on a corresponding network address assigned to the communication device 124, attribute information stored in the communication device 124, a device identifier assigned to the communication device 124 indicating its attributes or type, etc.

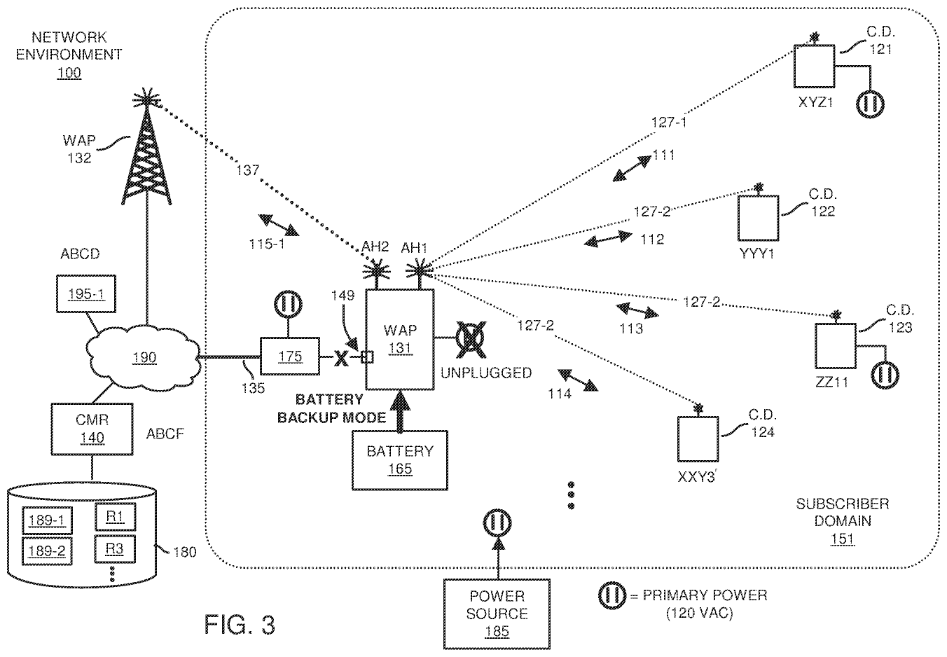

FIG. 3 is an example diagram illustrating a wireless system operating in a battery backup mode to provide wireless services to communication devices in a subscriber domain as discussed herein.

As previously discussed in FIG. 1, the wireless access point 131 provides the communication devices connectivity through the gateway 175 and shared communication link 135 to the remote network 190. However, as shown in FIG. 3, the wireless access point 131 becomes unplugged and is no longer powered via primary power from the primary power source 185 even though the primary power from the power source 185 is provided to other entities such as gateway 175, communication device 121, and communication device 123.

Because the wireless access point 131 becomes unplugged and is no longer powered by primary power provided by the power source 185, the wireless access point 131 switches over to operation in a battery backup mode in which the battery 165 supplies power to the wireless access point 131. While in the battery backup mode, in addition to receiving the power from the battery 165, the wireless access point switches over from use of the gateway 175 and shared communication link 135 to provide the corresponding communication devices access to the remote network 190.

More specifically, while in the battery backup mode during a condition in which the wireless access point 131 is unplugged from the primary power, the wireless access point no longer communicates through the gateway 175 and shared communication link 135 to the remote network 190. Instead, the wireless access point 131 establishes the backup wireless communication link 137 between the antenna hardware AH2 of the wireless access point 131 and the wireless access point 132 (such as a wireless base station providing cellular wireless services). The wireless communication link 137 supports communications 115-1, enabling each of the communication devices to continue to communicate with remote network 190 and corresponding destination communication devices.

In such an instance, during the battery backup mode, the communication device 121 has access to the remote network 190 via a respective communication path over wireless communication link 127-1, through the wireless access point 131 over the wireless communication link 137, through the wireless access point 132 to the remote network 190.

During the battery backup mode, the communication device 122 has access to the remote network 190 via a respective communication path over wireless communication link 127-2, through the wireless access point 131 over the wireless communication link 137, through the wireless access point 132 to the remote network 190.

During the battery backup mode, the communication device 123 has access to the remote network 190 via a respective communication path over wireless communication link 127-3, through the wireless access point 131 over the wireless communication link 137, through the wireless access point 132 to the remote network 190.

During the battery backup mode, the communication device 124 has access to the remote network via a respective communication path over wireless communication link 127-4, through the wireless access point 131 over the wireless communication link 137, through the wireless access point 132 to the remote network 190.

Thus, the wireless access point 131 (wireless station) a primary communication interface 149 and a secondary communication interface (such as antenna hardware AH2) to communicate with a remote network 190 depending upon whether the wireless access point is in the battery backup mode. As previously discussed, the primary communication interface 149 provides connectivity of the wireless access point 131 to the remote network 190 through the gateway 175 and the shared communication link 135. When used, the secondary communication interface such as the antenna hardware AH2 provides connectivity of the wireless access point 131 to the remote network 190 through the wireless communication link 137.

In a similar manner as previously discussed, the wireless access point 131 or other suitable entity provides status information 189-2 to the communication management resource 140. In the battery backup mode, the communication management resource 140 is in communication with the wireless access point 131 via a respective communication path including the network 190, wireless access point 132, and wireless communication link 137. Via conveyance of communications over the communication path, the wireless access point 131 or other suitable entity generates status information such as indicating a current operational mode of the wireless access point 131 and that it is operating off the battery 165 and switched over to use of the backup wireless communication link 137.

Additionally, via the communication path, the communication management resource receives status information 189-2 indicating the different wireless services provided by the wireless access point 131 at a particular one or more instances of time when the wireless access point 131 is operated in the battery backup mode. An example of the status information 189-2 shown in FIG. 4.

FIG. 4 is an example diagram illustrating a snapshot of wireless services provided by a wireless access point to communication devices after switchover of the wireless access point to backup power as discussed herein.

In one example, the status information 189-2 (wireless service information) is a snapshot of information indicating wireless services provided by the wireless access point 131 to one or more entities in the subscriber domain 151 while the wireless access point 131 operates in a battery backup mode as shown in FIG. 3 after to switchover of the wireless access point 131 being powered by the battery 165 and communicating over the wireless communication link 137.

Referring again to FIG. 4, while in the battery backup mode, the status information 189-2 in this example indicates that the wireless access point 131 provides wireless services to communication device 121 assigned the unique identifier value XYZ1 over the wireless communication link 127-1. Note that the communication management resource 140 or other suitable entity can be configured to determine a type associated with the communication device 121 in any suitable manner. For example, the wireless access point 131 can be configured to communicate with the communication device 121 or other suitable entity to retrieve information (such as device type, manufacture, model #, etc.) indicating that communication device 121 is a smart TV. In this example, in response to receiving the attribute information associated with the communication device 121, the status information 189-2 is generated to indicate one or more attributes such as: i) that the communication device 121 is a stationary communication device that does not move about the subscriber domain 151, ii) that the communication device 121 is powered by the primary power supplied by the power source 175 and that loss of the primary power results in shutoff of the communication device 121.

The status information 189-2 in this example indicates that the wireless access point 131 provides wireless services to communication device 122 assigned the unique identifier value YYZ1 over the wireless communication link 127-2. Note that the communication management resource 140 or other suitable entity can be configured to determine a type associated with the communication device 122 in any suitable manner. For example, the wireless access point 131 can be configured to communicate with the communication device 122 or other suitable entity to retrieve information (such as device type, manufacture, model #, etc.) indicating that communication device 122 is a mobile phone operated by a respective user. In this example, in response to receiving the attribute information associated with the communication device 122, the status information 189-2 is generated to indicate one or more attributes such as: i) that the communication device 122 is a mobile communication device that moves about the subscriber domain 151, ii) that the communication device 122 is powered by a battery and not the primary power supplied by the power source 175 and that loss of the primary power does not result in in shutoff of the communication device 122.

The status information 189-2 in this example indicates that the wireless access point 131 provides wireless services to communication device 123 assigned the unique identifier value ZZ11 over the wireless communication link 127-3. Note that the communication management resource 140 or other suitable can be configured to determine a type associated with the communication device 123 in any suitable manner. For example, the wireless access point 131 can be configured to communicate with the communication device 123 or other suitable entity to retrieve information (such as device type, manufacture, model #, etc.) indicating that communication device 123 is a stationary device such as a refrigerator powered by the primary power only. In this example, in response to receiving the attribute information associated with the communication device 123, the status information 189-2 is generated to indicate one or more attributes such as: i) that the communication device 121 is a stationary refrigerator that does not move about the subscriber domain 151, ii) that the communication device 123 is powered by the primary power supplied by the power source 175 and that loss of the primary power results in shutoff of the communication device 123.

The status information 189-2 in this example indicates that the wireless access point 131 provides wireless services to communication device 124 assigned the unique identifier value XXY3 over the wireless communication link 127-4. Note that the communication management resource 140 or other suitable entity can be configured to determine a type associated with the communication device 124 in any suitable manner. For example, the wireless access point 131 can be configured to communicate with the communication device 124 or other suitable entity to retrieve information (such as device type, manufacture, model #, etc.) indicating that communication device 124 is a mobile phone operated by a respective user. In this example, in response to receiving the attribute information associated with the communication device 124, the status information 189-2 is generated to indicate one or more attributes such as: i) that the communication device 124 is a mobile communication device that does moves about the subscriber domain 151, ii) that the communication device 124 is powered by a battery and not the primary power supplied by the power source 175 and that loss of the primary power does not result in in shutoff of the communication device 122.

In this example, it is noted that primary power is still supplied by the power source 185 to the communication device 121, communication device 123, and the gateway 175. Each of the communication devices 121, 122, 123, and 124, are still provided wireless access through the wireless access point to the remote network 190.

Referring again to FIG. 3, recall that the communication management resource 140 receives a notification from the wireless access point 131 or other suitable entity regarding status of the wireless access point 131. Assume that the notification indicates that the wireless access point 131 operates off the battery 165 instead of the primary power supplied by the power source 185. In such an instance, the communication management resource 140 can be configured to determine a cause of the operation of the wireless access point 131 in the battery backup mode via comparison of the status information 189-1 and the status information 189-2.

More specifically, in response to receiving the notification that the wireless access point 131 operates in the battery backup mode, the communication management resource 140 analyzes the wireless services provided by the wireless access point 131 (a.k.a., wireless station) while the wireless station is operated in the battery backup mode. Based on the analysis of the wireless services provided by the wireless access point 131 at different times, the communication management resource 140 determines a condition causing the operation of the wireless access point 131 (a.k.a., wireless station) in the battery backup mode.

More specifically, the communication management resource 140 receives first connectivity information (such as status information 189-1) indicating a first set of communication devices (121, 122, 123, and 124) provided wireless connectivity to the wireless station prior to the operation of the wireless access point 131 in the battery backup mode. The communication management resource 140 receives second connectivity information (such as status information 189-2) indicating a second set of communication devices (121, 122, 122, 124) provided wireless connectivity to the wireless station during the operation of the wireless access point 131 in the battery backup mode. To determine the cause of the switchover of the wireless access point 131 from the primary power to the battery power provided by the battery 165, the communication management resource 140 compares the first connectivity information and the second connectivity information to determine which of one or more communication devices no longer is able to communicate with the wireless station after switchover of the wireless station to the battery backup mode.

In this example, all of the communication devices 121, 122, 123, and 124, are wirelessly connected to the wireless access point 131. Because the communication device 121 in the communication device 123 both rely on receiving primary power for operation, and because both the communication device 121 in the communication device 122 are still wirelessly connected to and receiving data from the wireless access point 131 while in the battery backup mode, the communication management resource 140 concludes that the cause of the switchover of the wireless access point 131 from the primary power to the back of power provided by the battery 165 is most likely due to the wireless access point 131 no longer receiving power because the device was unplugged from the primary power. In other words, the communication management resource 140 determines that the condition causing the wireless access point 131 to operate in the battery backup mode is due to a subscriber (any person in the subscriber domain 151 accidentally or intentionally terminating application of primary power to the wireless access point 131 because it is inferred that primary power is supplied to the subscriber domain 151 because the communication device 121 and the communication device 123 are still operable. As previously discussed, the termination of the primary power to the wireless access point causes the wireless access point 131 to switch over from a normal operational mode to the battery backup mode.

In certain instances, it is undesirable to operate the wireless access point 131 in the battery backup mode when primary power is available from the power source 185. In response to detecting the above condition in which the wireless access point 131 is most likely unplugged with respect to the primary power because stationary devices are detected as still being operable via corresponding wireless communication links, the communication management resource 140 provides notification of the condition to a user in a subscriber domain 151 in which the wireless access point 131 resides.

In accordance with further examples, note that the analysis of the wireless connectivity between the wireless access point 131 and the corresponding communication devices to determine a cause of the switchover of the wireless access point 131 to the battery backup mode can include receiving an identity (such as unique identifier value XYZ1) of a first communication device 121 provided access to a remote network 190 through the wireless access point 131 via the wireless vacation link 127-1. The communication management resource 140 can be configured to map the identity of the first communication device 121 to attributes of the first communication device 121. The attributes associated with the communication device 121 may indicate that the communication device 121 is a stationary device disposed in the subscriber domain 151 serviced by the wireless access point 131. Further in this example, in response to the communication management resource 140 or other suitable entity detecting that the communication device 121 is a stationary device, and that the stationary device (121) is one that is normally powered by a primary power supplied to a subscriber domain in which the wireless access point 131 resides, the communication management resource 140 determines that the condition causing the operation of the wireless access point 131 in the battery backup mode was caused by a person or user in the subscriber domain terminating application of primary power to the wireless access point 131. In other words, as previously discussed, since the communication device 121 still operates while the wireless access point 131 is in the battery backup mode, it is likely that primary power was not lost at the subscriber domain 151.

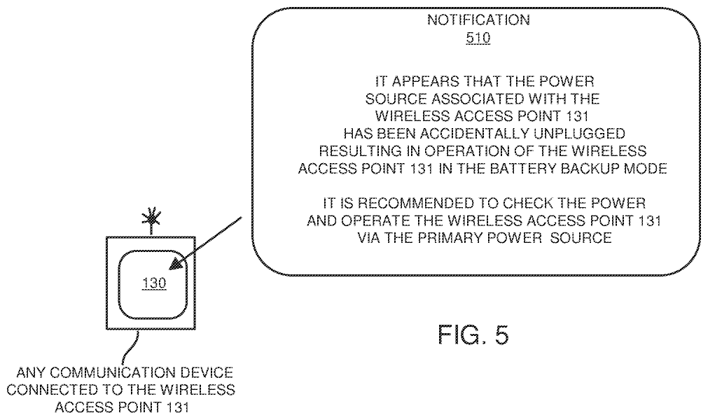

FIG. 5 is an example diagram illustrating communication of a notification to one or more communication devices indicating a detected cause associated with operating the wireless access point in a battery backup mode as discussed herein.

As previously discussed, the communication management resource 140 or other suitable entity can be configured to generate a respective notification 510 indicating occurrence of the operation of the wireless access point 131 in the battery backup mode. It may be more desirable to operate in the normal mode during a condition in which the primary power is available to the wireless access point 131 because use of the secondary interface such as the antenna hardware AH2 (and not the primary interface 149) may result in extra fees associated with use of wireless services (such as cellular services).

In this example, the communication management resource 140 determines that the cause of the wireless access point 131 operating in the battery backup mode is most likely caused by operator error such as that the wireless access point 131 was accidentally unplugged from the primary power. In response to detecting this condition, the communication management resource 140 or other suitable entity receives communication of the notification 510 to any of one or more persons in the subscriber domain 151 to notify them that the wireless access point 131 is operating on backup power.

Note that the notification 510 is shown in FIG. 5 can be displayed on any display screen of a respective communication device (such as displayed on one or more of communication device 121, 122, 123, and 124). In such an instance, the notification 510 prompts a respective user viewing the notification 510 to check that the wireless access point 131 is plugged into the primary power source 185 to receive primary power. In response to condition in which the user in the subscriber domain 151 connects the wireless access point 131 to primary power again, the wireless access point 131 switches over to operation in the normal mode again as shown in FIG. 1.

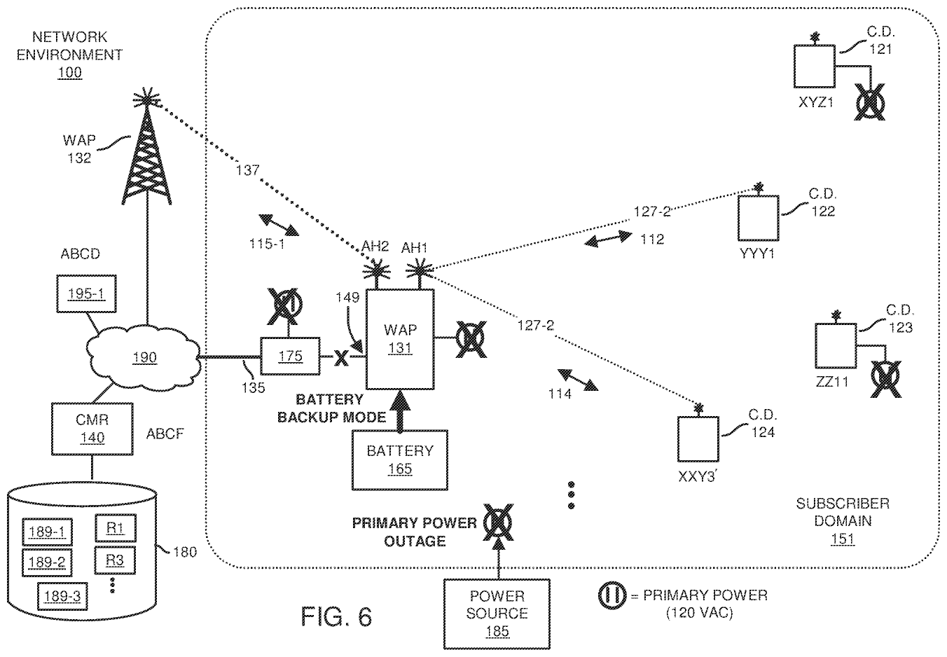

FIG. 6 is an example diagram illustrating a wireless system operating a battery backup mode to provide wireless services to communication devices in a subscriber domain as discussed herein.

Subsequent to a time of the user in the subscriber domain 151 supplying primary power to the wireless access point 131 again (see operation in FIG. 1) as a response to the notification 510, assume that the subscriber domain 151 experiences a respective primary power outage as shown in FIG. 6 in which the power source 185 no longer provide primary power to the subscriber domain 151. In other words, prior to operation of the wireless access point 131 as shown in FIG. 6, the wireless access point is operated as shown in FIG. 1.

As shown in FIG. 6, note that when primary power is no longer supplied to the subscriber domain 151 via the power source 185, the gateway 175, communication device 121, and communication device 123 are no longer functional because they lose power. This means that they are no longer able to support communications or corresponding wireless communication link.

In a similar manner as previously discussed, in response to the termination of the power source 185 supplying primary power to the wireless access point 131, the wireless access point 131 switches over to the battery backup mode in which the wireless access point 131 is powered by the battery 165. Additionally, during the battery backup mode, the wireless access point 131 switches over from using the primary communication interface 149 to using the secondary communication interface (such as antenna hardware AH2) to provide connectivity through the wireless access point 132 to the remote network 190. Wireless communication link 127-1 and wireless communication link 127-3 are terminated.

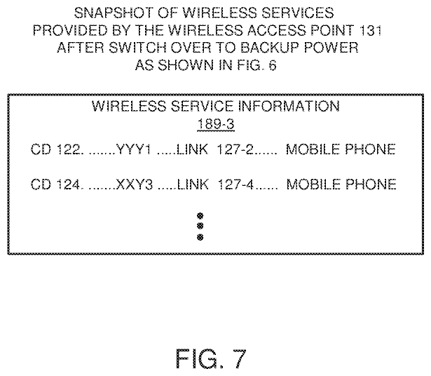

Also, in a similar manner as previously discussed, in response to switch over of the wireless access point 131 being powered by the battery 165, the wireless access point 131 can be configured to communicate a respective message over the wireless communication link 137 through the wireless access point 132 to the communication management resource 140. The message indicating operation of the wireless access point 131 in the battery backup mode can occur in any suitable manner. The respective message indicates that the wireless access point 131 operates in the battery backup mode. Additionally, in a similar manner as previously discussed, the wireless access point 131 or other suitable entity generates status information 189-3 (FIG. 7) indicating the different wireless services provided by the wireless access point 131 to the communication devices in the subscriber domain 151.

FIG. 7 is an example diagram illustrating a snapshot of wireless services provided by a wireless access point after switchover of the wireless access point to a backup mode as discussed herein.

In one example, the status information 189-3 is a snapshot of information indicating wireless services provided by the wireless access point 131 to one or more entities in the subscriber domain 151 while the wireless access point 131 operates in a battery backup mode as shown in FIG. 6 after to switchover of the wireless access point 131 being powered by the battery 165. As previously discussed, the switch over occurred as a response to loss of primary power supplied by the power source 185 to the subscriber domain 151. This means multiple devices in the subscriber domain are no longer functional.

Referring again to FIG. 7, while in the battery backup mode, the status information 189-3 in this example indicates that the wireless access point 131 provides wireless services to communication device 122 assigned the unique identifier value YYY1 over the wireless communication link 127-2. Additionally, the status information 189-3 indicates that the wireless access point 131 provides wireless services to the communication device 124 assigned the unique identifier value XXY3 over the wireless communication link 127-4.

Recall that the communication device 122 and the communication device 124 are both mobile phone devices that operate off of a respective internal battery with respect to the device. This means that they are not affected by the loss of primary power provided by the power source 185.

However, it is noted that the communication device 121 and the communication device 123 rely on primary power from the power source 185 for operation. In response to the primary power outage, the communication device 121 and the communication device 123 are no longer able to communicate with the wireless access point 131. In such an instance, the wireless communication link 127-1 in the wireless communication link 127-3 are terminated in response to the primary power outage. The status information 189-3 reflects this condition.

Referring again to FIG. 6, recall that the communication management resource 140 receives a notification from the wireless access point 131 or other suitable entity. The notification indicates that the wireless access point 131 operates off the battery 165 instead of the primary power supplied by the power source 185. In such an instance, the communication management resource 140 can be configured to determine a cause of the operation of the wireless access point 131 in the battery backup mode via comparison of the status information 189-3 and the status information 189-1.

More specifically, in response to receiving the notification that the wireless access point 131 operates in the battery backup mode in an instant in time shown in FIG. 6, the communication management resource 140 analyzes the wireless services provided by the wireless access point 131 (a.k.a., wireless station) while the wireless station is operated in the battery backup mode. Based on the analysis of the wireless services provided by the wireless access point 131 at different times, in one example, the communication management resource 140 determines a condition causing the operation of the wireless access point 131 (a.k.a., wireless station) in the battery backup mode.

More specifically, the communication management resource 140 receives first connectivity information (such as status information 189-1) indicating a first set of communication devices (121, 122, 123, and 124) provided wireless connectivity to the wireless access point 131 while the wireless access point 131 is operated in the normal mode prior to the operation of the wireless access point 131 in the battery backup mode. The communication management resource 140 receives third connectivity information (such as status information 189-3) indicating a second set of communication devices (122, 124) provided wireless connectivity to the wireless station during the operation of the wireless access point 131 in the battery backup mode. To determine the cause of the switchover of the wireless access point 131 from the primary power to the battery power provided by the battery 165, the communication management resource 140 compares the first connectivity information and the third connectivity information to determine which of one or more communication devices no longer is able to communicate with the wireless station after switchover of the wireless station to the battery backup mode.

In this example, after switchover of the wireless access point 131 to the battery backup mode is shown in FIG. 6, only the communication devices 122 and 124, are wirelessly connected to the wireless access point 131 and provided wireless service. Because the communication device 121 and the communication device 123 both rely on receiving primary power for operation, and because both the communication device 122 in the communication device 124 are still wirelessly connected to and receiving data from the wireless access point 131 and both the communication device 121 and communication device 123 are no longer provided wireless service while in the battery backup mode, the communication management resource 140 concludes that the cause of the switchover of the wireless access point 131 from the primary power to the backup power provided by the battery 165 is most likely due to a loss of primary power provided by the power source 185. In other words, it is known that the communication device 121 and communication device 122 do not operate unless there is a primary power supplied by the power source 185 to the subscriber domain 151. The termination of wireless services to the communication device 121 and the communication device 123 in conjunction with switchover of the wireless access point 131 to the backup mode indicates that the most likely cause of the switchover of the wireless access point from the primary power source 185 to the battery 165 is loss of the primary power.

In response to detecting the above condition in which the wireless access point 131 is most likely operating the battery backup mode because of loss of the primary power to the entire subscriber domain 151, the communication management resource 140 provides notification of the condition to a user in a subscriber domain 151 in which the wireless access point 131 resides.

Accordingly, examples herein include the communication management resource 140 determining the switchover to the battery backup mode as being a loss of primary power caused by a power outage in a household (subscriber domain 151) in which the wireless station resides.

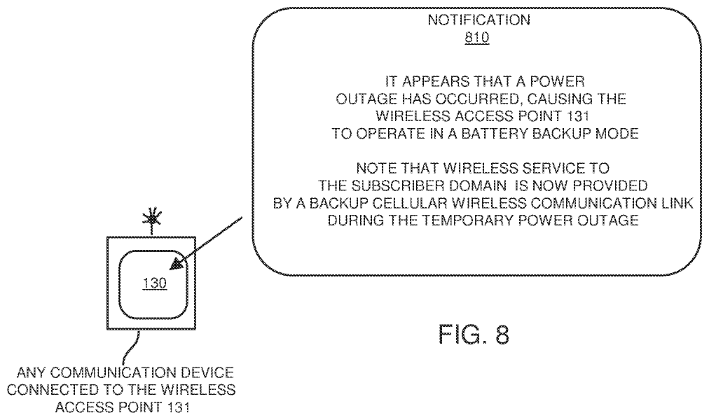

In response to detecting that switchover of the wireless access point 131 to the battery backup mode based on a respective primary power outage, the communication management resource 140 or other suitable entity initiates display of notification 810 in FIG. 8 on any of the communication device 122 or communication device 124 still operable.

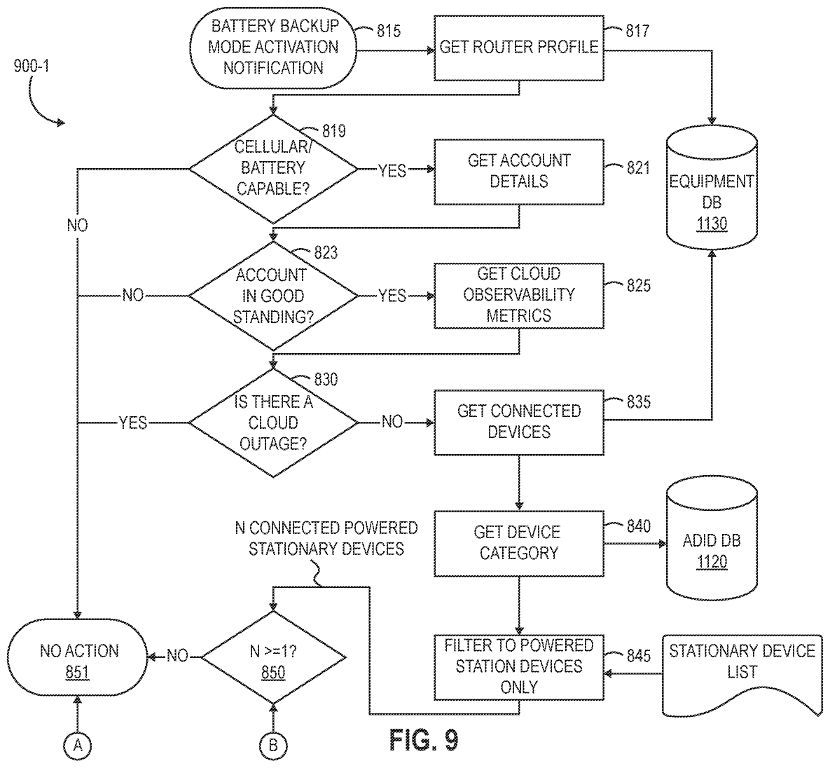

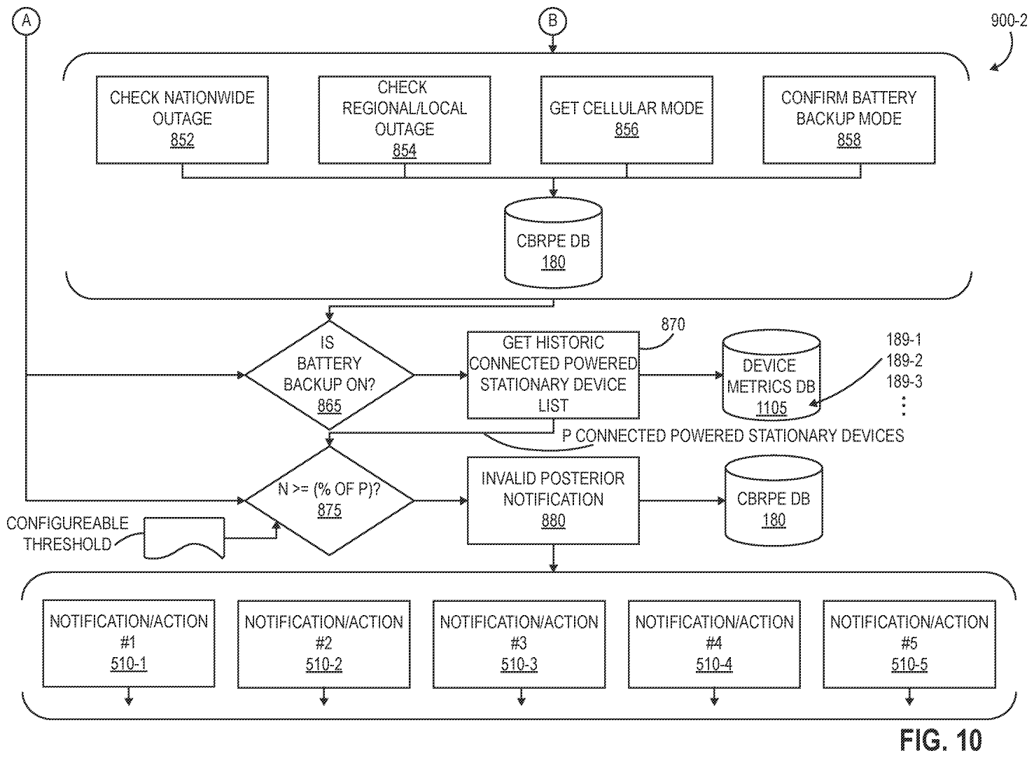

FIGS. 9 and 10 are example flowcharts illustrating operations associated with a wireless system as discussed herein.

As discussed herein, the wireless access point 131 supports cellular backup (via the antenna hardware AH2 such as a backup communication interface) and battery backup (via the battery 165). Examples herein include the capability of providing customers such as associated with the subscriber domain 151 with the ability to maintain critical connectivity to a remote network 190 such as the Internet for a period of time (depending upon energy in the battery 165) in case there is loss of primary power from the power source 185 and/or connectivity through the gateway 175 and the shared communication link 135 (e.g., loss of power to the customer's premise, loss of internet provided over cable/fiber modem to the router).

This disclosure proposes leveraging features such as network intelligence and so-called Advanced Device Identification associated with the supported communication devices 121, 122, 123, 124, etc., to determine if a primary power outage observed at a subscriber domain was at a was a regional or local in nature (i.e., at a router level). The Advanced Device Identification information associated with each of the respective communication devices enables the communication management resource 140 to determine attributes of those devices in the subscriber domain 151 such as whether they are only powered by primary power in the subscriber domain or whether they typically run on battery backup or simply just run on a battery such as a mobile phone.

By noting the powered devices connected to the router (a.k.a., wireless access point 131) before and after the router went into battery backup mode, the system as discussed herein can be configured to determine whether the power outage was noticed across the entire household or just for the specific router (e.g., if the wireless access point 131 is operated via battery backup and it is determined that a communication device such as a Smart TV's that require continuous power is still provided wireless service while in the battery backup mode), the communication management resource 140 or other suitable entity infers that the location such as a subscriber domain 151 is supplied with primary power from the power source 185. In other words, as previously discussed, if communication device 121 and communication device 123 still use the respective wireless communication links before and after the corresponding switchover from normal to battery backup mode, then it is assumed that primary power still available to all of the devices in the subscriber domain.

Techniques as discussed herein are useful because a respective user in the subscriber domain 151 may terminate power to the wireless access point 131 or the gateway 175 for various reasons such as that no one in the household using internet at night or no one using internet outside of business hours. This may result in additional usage of the cellular backup functionality that is undesirable.

Determination that a respective location such as a subscriber domain 151 has power but the router (a.k.a., wireless access point 131) is in a battery backup mode enables the communication management resource 140 or other suitable entity to notify the customer proactively to check their router connection status, and if necessary allow the communication management resource 140 or other suitable entity to throttle down/temporarily disable the cellular back up service provided by the antenna hardware AH2 (secondary interface) of the corresponding wireless access point to prevent additional cellular data use/charges to the subscriber associated with the subscriber domain.

### Components

The system as discussed herein can be configured to implement one or more of the following components to identify a router in an incorrect battery and/or cellular backup mode (not an exhaustive list):
Systemic network outage notifications
Local Service Group outage notifications.
Node outage notifications.
Router Cloud outage notifications.
Advanced Device ID (ADID).
Device categorization using ADID.
Device connection quality scores based on ADID.
Router telemetry
Cellular traffic detection.
Cellular traffic metering
Neighboring SSIDs

In one example, the communication management resource 140 is or includes a so-called Cellular/Battery backup Router Posture Evaluator (CBRPE).

The communication management resource 140 and its corresponding functionality can be configured to reside at any suitable one or more locations such as at middleware layer and/or an ISP PS layer. The communication management resource 140 receives inputs from the various connected systems for a cloud connected router and monitors for instances where an applicable router is detected as being in an invalid posture (‘Invalid posture’ as described herein). If detected, the communication management resource 140 can be configured to alert any entity in the network environment 100.

The communication management resource 140 or other suitable entity can be configured to choose to alert the customer and based on the global/customer set rules, it will take action (e.g., throttle speeds after a certain period of time/certain amount of cellular traffic, temporarily disable cellular connectivity over the wireless vacation link 137 after a certain period of time/certain amount of cellular traffic).

In other words, in addition to or as an alternative to providing notification 510 to the one or more persons in the subscriber domain 151 indicating that the wireless access point 131 operates off the battery backup as a result of the wireless access point 131 being unplugged or other similar intentional or accidental reason, the communication management resource 140 or other suitable entity in the network environment can be configured to transmit bandwidth control communications to the wireless access point operating in the battery backup mode as shown in FIG. 3 because it is determined that the wireless access point 131 should not be operating in the battery backup mode because primary power is available. The commands may limit the amount of bandwidth provided over the wireless communication link 137, resulting in a noticeable degradation of wireless services to the communication devices 121, 122, 123, etc. This is one way that users in the respective subscriber domain may be notified of the improper operation of the wireless access point in the battery backup mode.

In one example, the communication management resource 140 such as implementing a CBRPE performs the following operations after a router (such as wireless access point 131) comes online in a Cloud Management system.

Note that telemetry may be recorded for each of these operations in a periodic time interval and the checks can be run on an automated schedule or initiated systemically.
1. CBRPE checks the model of the router to see if it is within its list of applicable routers to evaluate. (If yes, proceed to next step of the check)
2. Is the router on an account in good standing? (if yes, proceed to next step of the check)
3. Is there a router management cloud outage? (if no, proceed to next step of the check)
4. Is there a nationwide network outage? (Note response and proceed)
5. Is there a regional/local network outage? (Note response and proceed)
6. Is the router in a cellular backup mode? (Note response and proceed)
7. Are there devices connected to the router? (if yes, proceed)
8. Does the communication management resource 140 have the Advanced Device Identification (ADID) data (such as attributes of the different communication devices in a wireless connectivity with the wireless access point 131) for the devices (121, 122, 123, 124, etc.) connected to identify its type? (if yes, proceed)
9. Powered (continuously powered through mains or primary power provided by power source 185) stationary device check (such as communication device 121, and communication device 123, are determined to be stationary devices via this check) could include but is not limited to Access Points (Pods/Extenders), Routers, Set Top Boxes, Computers, Smart TVs, TVs, Game Consoles, Streaming Video Devices? (if yes, proceed)
10. Is the router (a.k.a., wireless access point 131) in a battery backup mode? (if yes, proceed)
11. Based on a configurable threshold associated with the number of powered devices identified before and after the device goes into battery backup mode, the communication management resource 140 or other suitable entity will determine the router (a.k.a., wireless access point 131) to be in an invalid state (e.g., If the communication management resource 140 detects a 20% drop in the number of connected Continuously powered devices such as those that continuously operate off of the primary power provided by the power source 185, the router is flagged as being in an invalid state).
12. If in an invalid posture (such as a case in which the wireless access point 131 and/or the gateway 175 are unplugged from the primary power), the communication management resource 140 or other suitable entity can be configured to perform one or more of the following actions (not an exhaustive list, multiple options could be selected)
a. Notify customer to troubleshoot their connections via preferred communications channels to self-serve or contact customer support e.g. email, text (BAU), app notification
b. In App/Spectrum.net banner notification (display a notification of the condition and a corresponding banner)
c. Monitor usage and adjust speed associated with conveying communications over the wireless communication link 137 if data usage crosses a certain threshold
d. Monitor usage and stop cellular access (such as terminate wireless communication link 137) if data usage associated with a wireless communication link 137 increases above a certain threshold
e. Display an alert banner on Customer care management tool
f. Display an alert banner on Field care management tool
g. Charge customer associate with a respective subscriber domain a higher rate after a certain period of time/data usage
h. Suspend router services (disable SSID, disable LAN ports, disable access to the internet) provided by the respective wireless access point 131

Now with more specific reference to the flowchart 900 in FIGS. 9 and 10 (presented as flowchart 900-1 and flowchart 900-2), the communication management resource 140 receives the notification 815 indicating operation of the wireless access point 131 in the battery backup mode.

In processing operation 817 of FIG. 9, in response to receiving the notification 815, the communication management resource accesses the database 1130 to retrieve a corresponding router profile associated with the wireless access point 131.

In processing operation 819, the communication management resource 140 determines whether the wireless access point 131 supports a respective battery backup mode (cellular backup and battery backup). If not, processing continues at operation 851 where no action is taken. Conversely, if the wireless access point 131 is determined as supporting battery backup capability as indicated by the retrieved profile in operation 819, the communication management resource retrieves account details associated with the subscriber domain 151 in processing operation 821.

In processing operation 823, the communication management resource 140 determines if the account associated with the subscriber domain 151 is in good standing. If not, flow continues at processing operation 851. Conversely, if the wireless access point is in good standing such as because all bills are paid to use respective services, processing continues at processing operation 825.

In processing operation 825, the wireless access communication management resource 140 obtains cloud observability metrics associated with the wireless access point 131 and corresponding subscriber domain 151 and possibly other subscriber domains in the vicinity of subscriber domain 151. If a cloud outage is detected, then processing continues at processing operation 851. Conversely, if no cloud outage is detected in processing operation 830, the communication management resource retrieves information (such as any status information as discussed herein) indicating the communication devices serviced by the wireless access point 131.

In processing operation 840, the communication management resource 140 accesses the database 1120 to determine attributes associated with each of the communication devices 121, 122, 123, 124, etc., provided wireless services in the subscriber domain 151.

In processing operation 845, the communication management resource 140 filters the communication devices to determine which of the communication devices in the subscriber domain 151 are stationary devices powered only by the primary power supplied by the power source 185. The communication management resource 140 can be configured to determine a number of communication devices and how many devices are stationary devices powered by the primary power only.

In processing operation 850, if the number of communication devices N is less 1, then processing continues at operation 851. Conversely, if the communication management resource determines that there is one or more one stationary communication device in the subscriber domain provided wireless services and that is powered only by the primary power, the communication management resource executes one or more of the operations 852, 854, 856, and 858 in FIG. 10.

In processing operation 852 in flowchart 900-2 in FIG. 10, the communication management resource 140 can be configured to check for occurrence of any nationwide power outage that may affect the subscriber domain 151.

In processing operation 854, the communication management resource 140 checks whether there is any regional or local power outage possibly causing the battery backup operation by the wireless access point 131.

In processing operation 856, the communication management resource 140 obtains cellular modem information associated with the subscriber domain to determine if this is the cause of the switchover of the wireless access point to the battery backup mode.

In processing operation 858, the communication management resource 140 confirms the type associated with the wireless access point and operation in the battery backup mode.

Results of the prior processing operations 852, 854, 856, 850 can be stored in the repository 180 or other suitable entity.

As further shown, in processing operation 865, the communication management resource 140 determines whether or not the battery backup mode is on for the wireless access point 131. If not, processing continues at processing operation 851. Conversely, if the wireless access point 131 is determined to be operating in the battery backup mode, the communication management resource 140 executes the processing operation 870.

In processing operation 870, the communication management resource 140 accesses the corresponding database 1105 to retrieve historical power information such as status information 189-1, status information 189-2, status information 189-3, etc. Via the retrieved historical connection information, the communication management resource 140 produces a respective value P indicating the number of connected powered stationary devices.

In processing operation 875, the communication management resource 140 compares the value N and the value percent of P. If the percent of connected powered stationary devices is less than or equal to the value N, then processing continues at operation 880. Otherwise, flow continues at operation 851.

In processing operation 880, in response to detecting the improper operation of the wireless access point 131 in the battery backup mode, the communication management resource 140 stores such information regarding the condition in the repository 180. Additionally, as previously discussed, the communication management resource 140 or other suitable entity can be configured to provide notification of the improper operation of the wireless access point 131 in the battery backup mode via generation of one or more notifications including: notification 510-1, notification 510-2, the notification 510-3, notification 510-4, notification 510-5, etc., and then communication of any of the notifications to any of one or more of the communication devices and/or persons in the subscriber domain 151.

Accordingly, examples herein include providing notification to one or more communication devices in a respective subscriber domain in response to detecting that the wireless access point 131 appears to be needlessly operating in the battery backup mode.

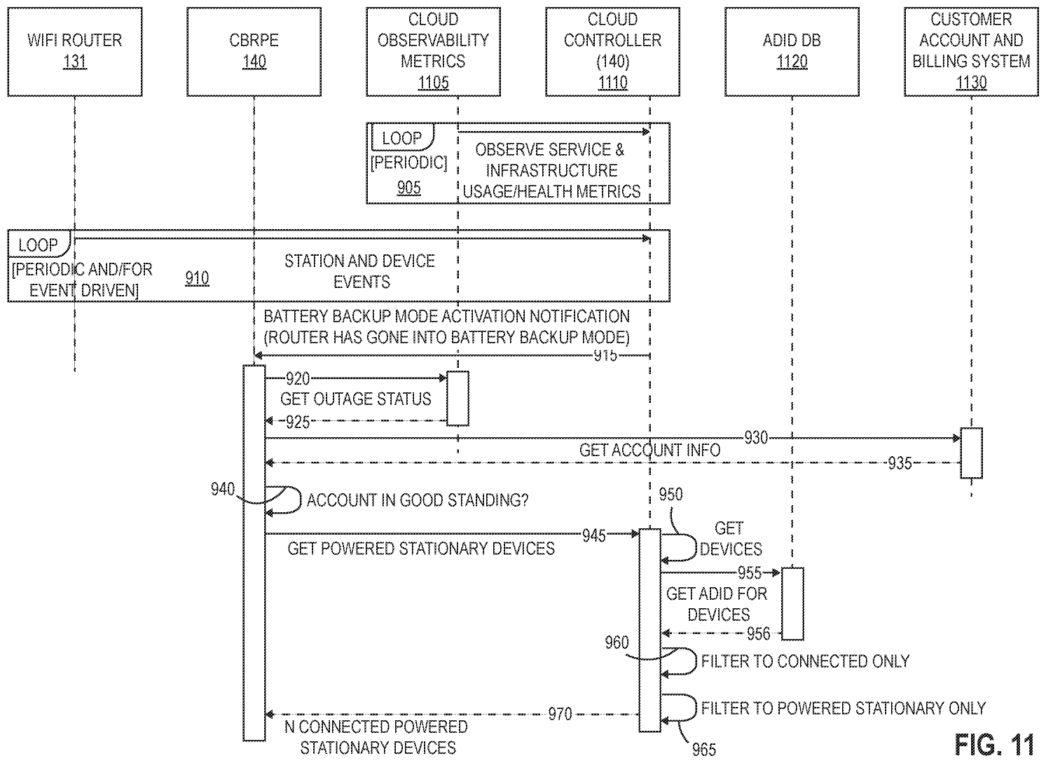

FIG. 11 is an example diagram illustrating operations and communication flows associated with a wireless system configured to provide backup capability as discussed herein.

In this example, via communications 905, the cloud controller 1110 (potentially function associated with the communication management resource 140) receives cloud observability metrics associated with the one or more wireless access points in the network environment 100.

Via communications 910, the cloud controller 1110 receives station and device event information from the wireless access point 131. This can include notification indicating that the wireless access point 131 operates in the battery backup mode.

Via communications 915, the cloud controller 1110 provides notification to the communication management resource 140 that the wireless access point 131 has switched over to the battery backup mode.

Via communications 920, the communication management resource 140 communicates a request to the cloud observability metrics 1105 regarding power outage status information.

Via communications 925, the communication management resource 140 is informed of any power outages in different regions.

Via the communications 930, the communication management resource 140 communicates a request for account information associated with the wireless access point 131.

Via communications 935, the communication management resource 140 receives account information associated with the wireless access point 131 from the system 130.

In processing operation 940, the communication management resource 140 determines whether the account associated with the wireless access point 131 as indicated by the retrieved account information is in good standing such as whether all bills have been paid.

Via communications 945, the communication management resource 140 communicates with the cloud controller 1110 to obtain information regarding communication devices in the subscriber domain 151 that are powered stationary devices via primary power provided by the power source 185.

In processing operation 950, the cloud controller 1110 obtains information associated with the communication devices in the subscriber domain 151 that are provided wireless access via the wireless access point 131.

Via communications 955, the cloud controller 1110 requests information about the communication devices in the subscriber domain 151 from the database 1120.

Via communications 956, the database 1120 provides attribute information associated with the communication devices in the subscriber domain 151. As previously discussed, the attribute information can indicate whether the device operates only on primary power or battery power or combination of both. The information can further indicate whether the devices stationary or nonstationary, suggesting whether or not the device operates on battery backup with respect to the primary power.

In processing operation 960, the cloud controller 1110 filters the list of devices to those that are connected to the wireless access point 131.

In processing operation 965, the cloud controller 1110 filters the information to produce a list of powered stationary devices in the subscriber domain 151 that require power from the primary power.

Via communications 970, the cloud controller 1110 notifies the communication management resource 140 of the number of connected powered stationary devices in the subscriber domain 151.

In processing operation 975, the communication management resource 140 determines whether the number N of devices is greater than 1.

Via communications 980, the communication management resource 140 communicates a request to the cloud controller 1110 for historic device metrics associated with the communication devices.

Via communications 985, the cloud controller 1110 provides the requested historical device metric information such as status information 189.

In processing operation 990, the communication management resource 140 evaluates the posture of applying threshold number of connected power stationary devices at the present time versus a prior time.

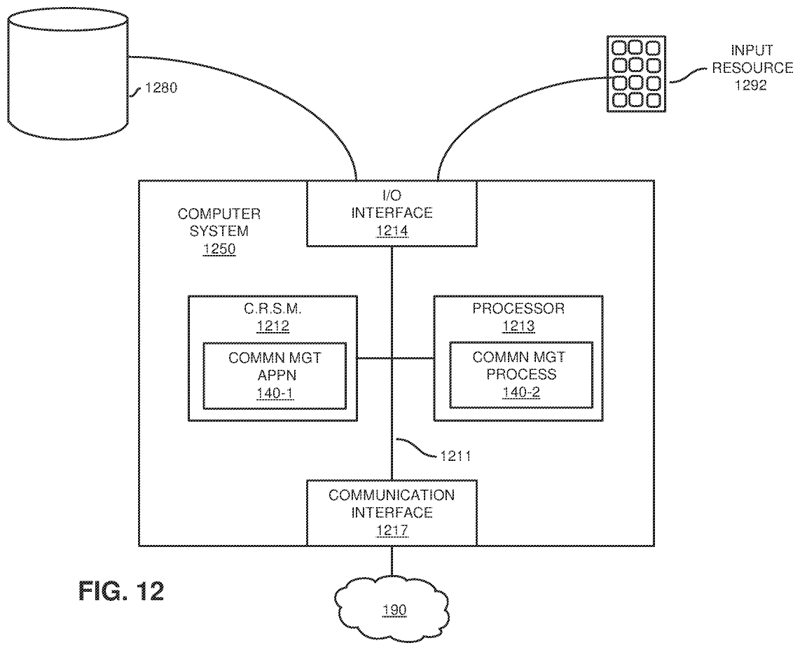

FIG. 12 is an example block diagram of a computer system for implementing any of the operations as previously discussed according to examples herein.

Any of the resources (such as wireless access point 131, gateway 175, wireless access point 132, communication management resource 140, mobile communication device 121, mobile communication device 122, etc.) as discussed herein can be configured to include computer processor hardware and/or corresponding executable instructions to carry out the different operations as discussed herein.

As shown, computer system 1250 of the present example includes an interconnect 1211 that couples computer readable storage hardware 1212 or any suitable type of hardware storage medium in which digital information can be stored and retrieved, a processor 1213 (computer processor hardware), I/O interface 1214, and a communications interface 1217.

I/O interface(s) 1214 supports connectivity to repository 1280 and input resource 1292.

Computer readable storage medium 1212 (also known as computer readable storage hardware) can be any hardware storage device such as memory, optical storage, hard drive, floppy disk, etc. In one example, the computer readable storage medium 1212 stores instructions and/or data.

As shown, computer readable storage media 1212 can be encoded with communication management application 140-1 (e.g., including instructions) to carry out any of the operations as discussed herein.

During operation of one example, processor 1213 accesses computer readable storage media 1212 via the use of interconnect 1211 in order to launch, run, execute, interpret or otherwise perform the instructions in management application 140-1 stored on computer readable storage medium 1212. Execution of the communication management application 140-1 produces communication management process 140-2 to carry out any of the operations and/or processes as discussed herein.

Those skilled in the art will understand that the computer system 1250 can include other processes and/or software and hardware components, such as an operating system that controls allocation and use of hardware resources to execute communication management application 140-1.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

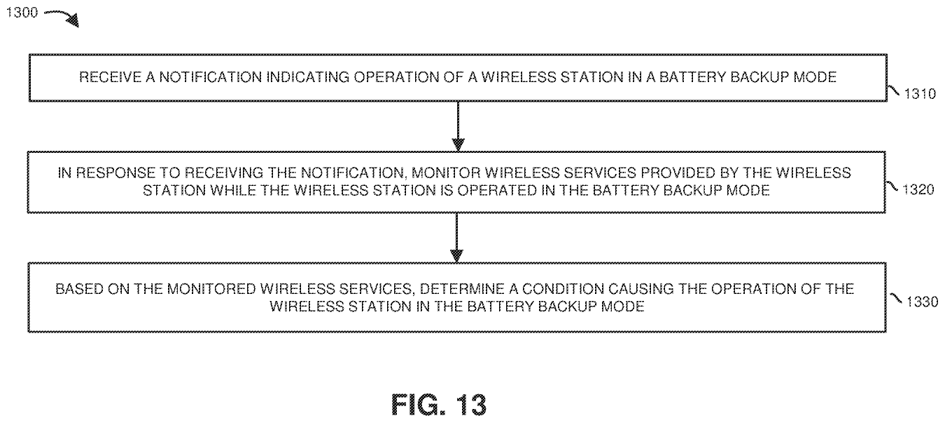

Functionality supported by the different resources will now be discussed via flowcharts in FIG. 13. Note that the steps in the flowcharts below can be executed in any suitable order.

FIG. 13 is a flowchart 1300 illustrating an example method according to examples. Note that there will be some overlap with respect to concepts as discussed above.

In processing operation 1310, the communication management resource 140 associated with the wireless access point 131 receives a notification indicating operation of a wireless station in a battery backup mode.

In processing operation 1320, in response to receiving the notification, the communication management resource 140 analyzes wireless services provided by the wireless station while the wireless station is operated in the battery backup mode.

In processing operation 1330, based on the monitored wireless services, the communication management resource 140 determines a condition causing the operation of the wireless station in the battery backup mode.

Note again that techniques herein are well suited to monitor and provide notifications associated with a respective wireless system. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
receiving a notification indicating operation of a wireless station in a battery backup mode;
in response to receiving the notification, analyzing wireless services provided by the wireless station while the wireless station is operated in the battery backup mode; and
based on the analyzed wireless services, determining a condition causing the operation of the wireless station in the battery backup mode.

2. The method as in claim 1, wherein the condition is determined to be a subscriber terminating application of primary power to the wireless station, the termination of the primary power to the wireless station causing the wireless station to switch over from a normal operational mode to the battery backup mode.

3. The method as in claim 2 further comprising:
providing notification of the condition to a user in a subscriber domain in which the wireless station resides.

4. The method as in claim 1, wherein the condition is determined to be a loss of primary power supplied to the wireless station, the loss of primary power caused by a power outage in a domain service by the wireless station.

5. The method as in claim 1, wherein the wireless services include a wireless communication link between a communication device and the wireless station.

6. The method as in claim 5, wherein analyzing the wireless services provided by the wireless station includes:
receiving an identity of the communication device provided access to a remote network through the wireless station via the wireless communication link; and
mapping the identity of the communication device to attributes of the first communication device, the attributes of the communication device indicating that the communication device is a stationary device disposed in a subscriber domain serviced by the wireless station.

7. The method as in claim 6 further comprising:
in response to detecting that the communication device is a stationary device, and that the stationary device is one that is normally powered by a primary power supplied to a subscriber domain in which the wireless station resides, determining that the condition causing the operation of the wireless station in the battery backup mode resulted from a user in the subscriber domain terminating application of primary power to the wireless station.

8. The method as in claim 1, wherein the wireless station includes a primary communication interface and a secondary communication interface to communicate with a remote network, the primary communication interface providing connectivity of the wireless station to the remote network through a wired communication link, the secondary communication interface providing connectivity of the wireless station to the remote network through a wireless communication link.

9. The method as in claim 8, wherein the operation of the wireless station in the battery backup mode includes the wireless station providing connectivity of a first communication device to the remote network via communications through the secondary communication interface.

10. The method as in claim 1, wherein determining the condition includes:
detecting multiple communication devices in communication with the wireless station while the wireless station is in the battery backup mode, the multiple communication devices provided connectivity through the wireless station to the remote network while the wireless station is in the battery backup mode;
producing a numerical value indicating how many of the multiple communication devices are stationary in a subscriber domain in which the wireless station resides;
comparing a magnitude of the numerical value to a threshold level; and
determining a type associated with the condition based on the comparison of the numerical value to the threshold level.

11. The method as in claim 1, wherein analyzing the wireless services includes:
receiving first connectivity information indicating a first set of communication devices provided wireless connectivity to the wireless station prior to the operation of the wireless station in the battery backup mode; and
receiving second connectivity information indicating a second set of communication devices provided wireless connectivity to the wireless station during the operation of the wireless station in the battery backup mode.

12. The method as in claim 11, wherein determining the condition includes:
comparing the first connectivity information and the second connectivity information to determine which of one or more communication devices no longer communicate with the wireless station after switchover of the wireless station to operating in the battery backup mode.

13. A system comprising:
communication management hardware operative to:
receive a notification indicating operation of a wireless station in a battery backup mode;
in response to receiving the notification, analyze wireless services provided by the wireless station while the wireless station is operated in the battery backup mode; and
based on the analyzed wireless services, determine a condition causing the operation of the wireless station in the battery backup mode.

14. The system as in claim 13, wherein the condition is determined to be a subscriber terminating application of primary power to the wireless station, the termination of the primary power to the wireless station causing the wireless station to switch over from a normal operational mode to the battery backup mode.

15. The system as in claim 14, wherein the communication management hardware is further operative to:
provide notification of the condition to a user in a subscriber domain in which the wireless station resides.

16. The system as in claim 13, wherein the condition is determined to be a loss of primary power supplied to the wireless station, the loss of primary power caused by a power outage in a domain serviced by the wireless station.

17. The system as in claim 13, wherein the wireless services include a wireless communication link between a communication device and the wireless station.

18. The system as in claim 17, wherein the communication management hardware is further operative to:
receive an identity of the communication device provided access to a remote network through the wireless station via the first wireless communication link; and
map the identity of the first communication device to attributes of the communication device, the attributes of the communication device indicating that the communication device is a stationary device disposed in a subscriber domain serviced by the wireless station.

19. The system as in claim 18, wherein the communication management hardware is further operative to:
in response to detecting that the communication device is a stationary device, and that the stationary device is one that is normally powered by a primary power supplied to a subscriber domain in which the wireless station resides, determine that the condition causing the operation of the wireless station in the battery backup mode resulted from a user in the subscriber domain terminating application of primary power to the wireless station.

20. The system as in claim 13, wherein the wireless station includes a primary communication interface and a secondary communication interface to communicate with a remote network, the primary communication interface providing connectivity of the wireless station to the remote network through a wired communication link, the secondary communication interface providing connectivity of the wireless station to the remote network through a wireless communication link.

21. The system as in claim 20, wherein the operation of the wireless station in the battery backup mode includes the wireless station providing connectivity of a first communication device to the remote network via communications through the secondary communication interface.

22. The system as in claim 13, wherein the communication management hardware is further operative to:
detect multiple communication devices in communication with the wireless station while the wireless station is in the battery backup mode, the multiple communication devices provided connectivity through the wireless station to the remote network while the wireless station is in the battery backup mode;
produce a numerical value indicating how many of the multiple communication devices are stationary in a subscriber domain in which the wireless station resides;
compare a magnitude of the numerical value to a threshold level; and
determine a type associated with the condition based on the comparison of the numerical value to the threshold level.

23. The system as in claim 13, wherein the communication management hardware is further operative to:
receive first connectivity information indicating a first set of communication devices provided wireless connectivity to the wireless station prior to the operation of the wireless station in the battery backup mode; and
receive second connectivity information indicating a second set of communication devices provided wireless connectivity to the wireless station during the operation of the wireless station in the battery backup mode.

24. The system as in claim 23, wherein the communication management hardware is further operative to:
compare the first connectivity information and the second connectivity information to determine which of one or more communication devices no longer communicate with the wireless station after switchover of the wireless station to operating in the battery backup mode.

25. Computer-readable storage hardware having instructions stored thereon, the instructions, when carried out by computer processor hardware, cause the computer processor hardware to:
receive a notification indicating operation of a wireless station in a battery backup mode;
in response to receiving the notification, analyze wireless services provided by the wireless station while the wireless station is operated in the battery backup mode; and
based on the analysis of the wireless services, determine a condition causing the operation of the wireless station in the battery backup mode.
